(19) United States
(12) Patent Application Publication
(10) Pub. No.: US 2012/0243567 A1
(43) Pub. Date: Sep. 27, 2012

(54) LASER IRRADIATION DEVICE AND MICROPARTICLE MEASURING DEVICE

(75) Inventors: Katsuhiro Seo, Kanagawa (JP); Hideya Chubachi, Kanagawa (JP)

(73) Assignee: SONY CORPORATION, Tokyo (JP)

(21) Appl. No.: 13/403,677

(22) Filed: Feb. 23, 2012

(30) Foreign Application Priority Data
Mar. 22, 2011 (JP) 2011-062129

(51) Int. Cl. H01S 3/13

(52) U.S. Cl. 372/29.011

(57) ABSTRACT

A laser irradiation device includes: a laser light source; a mirror that reflects a part of light output from the laser light source and allows the remainder to pass; an optical detector that detects reflection light reflected by the mirror; and a feedback control circuit that receives a signal output from the optical detector and controls the output of the laser light source to keep a signal intensity constant, wherein a thickness of the mirror is set such that a distance between a beam spot of the reflection light reflected by a front surface of the mirror on the detector and a beam spot of reflection light reflected by a back surface of the mirror on the detector is equal to or more than a predetermined value.

### BACKGROUND

The present disclosure relates to a laser irradiation device, and a microparticle measuring device, and more particularly, to a laser irradiation device that emits light with stable intensity from a laser light source.

In the related art, a microparticle measuring device is used in which microparticles flowing in a flow cell or in a flow path formed on a microchip are irradiated with light (laser beam); light scattered from the microparticles, the microparticles themselves, or fluorescent light generated from a fluorescent substance labeled on the microparticles is detected to measure optical characteristics of the microparticles. In the microparticle measuring device, as a result of measuring the optical characteristics, separate collection of a population (group) determined as satisfying a predetermined condition from microparticles is performed. Particularly, a device that measures optical characteristics of cells as the microparticles or performs separate collection of cell groups satisfying a predetermined condition is called a flow cytometer or a cell sorter.

For example, in Japanese Unexamined Patent Application Publication No. 2007-46947, “a flow cytometer provided with a plurality of light sources irradiating a plurality of types of excitation light having wavelengths different from each other in a predetermined period and phases different from each other, and a light guide member guiding the plurality of types of excitation light to the same incident path to collect the light at stained particles” is disclosed. The flow cytometer includes a plurality of light sources irradiating a plurality of types of excitation light having wavelengths different from each other, a light guide member guiding the plurality of types of excitation light to the same incident path and collecting the light at stained particles, and a plurality of fluorescence detectors detecting fluorescent light generated by exciting the particles with the plurality of types of excitation light and outputting fluorescence signals (in Japanese Unexamined Patent Application Publication No. 2007-46947, Claims 1 and 3, FIGS. 1 and 3).

### SUMMARY

In the flow cytometer, to accurately measure the optical characteristics of the microparticles, it is necessary to irradiate the microparticles with light with a stable intensity. When the intensity of the light irradiating the microparticles is changed, an error occurs in the measured intensity of scattered light and fluorescent intensity, and precision in measurement is decreased.

It is desirable to provide a laser irradiation device which can irradiate light from a laser light source with a stable intensity.

According to an embodiment of the present disclosure, there is provided a laser irradiation device including: a laser light source; a mirror that reflects a part of light output from the laser light source and allows the remainder to pass; an optical detector that detects reflection light reflected by the mirror; and a feedback control circuit that receives a signal output from the optical detector and controls the output of the laser light source to keep a signal intensity constant, wherein a thickness of the mirror is set such that a distance between a beam spot of the reflection light reflected by a front surface of the mirror on the detector and a beam spot of reflection light reflected by a back surface of the mirror on the detector is equal to or more than a predetermined value.

In the laser irradiation device, the distance may be any one of a beam diameter 1/e² or a full width at half maximum of the light.

Since the distance is equal to or more than such a value, it is possible to perform the detection of the reflection light by the optical detector under a condition of suppressing interference between the reflection light reflected by the front surface of the mirror and the reflection light reflected by the back surface of the mirror.

In the laser irradiation device, the mirror may be a wedge-shaped mirror.

Since the mirror is the wedge-shaped mirror, it is possible to further suppress the interference between the reflection light reflected by the front surface of the mirror and the reflection light reflected by the back surface of the mirror.

According to another embodiment of the present disclosure, there is provided a microparticle measuring device including the laser irradiation device, wherein the light passing through the mirror is irradiation light for microparticles.

In the present disclosure, the “1/e²” means a distance between two symmetry points in which light intensity in the vicinity of a unit area is 1/e² of the maximum value on the light irradiation surface. The “full width at half maximum” means a distance between two symmetry points in which light intensity in the vicinity of a unit area is 1/2 of the maximum value.

In the present disclosure, the “microparticles” broadly include biological microparticles such as cells, microorganisms, and liposomes, or synthetic particles such as latex particles, gel particles, and industrial particles.

The biological microparticles include chromosomes, liposomes, mitochondria, and organelles (cell minute organ). Cells as a target include animal cells (blood cells or the like) and plant cells. Microorganisms include bacteria such as Escherichia coli, viruses such as tobacco mosaic virus, and funguses such as yeast. Biological microparticles may include biological polymers such as nucleic acids, proteins, and complexes thereof. Industrial particles may be, for example, organic or inorganic polymer materials, and metals. Organic polymer materials include polystyrene, styrene-divinylbenzene, and polymethyl methacrylate. Inorganic polymer materials include glass, silica, and magnetic materials. Metals include colloidal gold and aluminum. The shapes of the microparticles are generally spherical, but may be not spherical, and sizes and masses are not particularly limited.

According to the present disclosure, the laser irradiation device capable of outputting light with a stable intensity from the laser light source is provided.

### BRIEF DESCRIPTION OF THE DRAWINGS

FIG. 1 is a schematic diagram illustrating a configuration of a laser irradiation device according to a first embodiment of the present disclosure.

FIG. 2 is a schematic diagram illustrating a thickness of a flat mirror.

FIG. 3A and FIG. 3B are schematic diagrams illustrating a beam spot distance between a front surface reflection light and a back surface reflection light on an optical detector of the laser irradiation device according to the first embodiment.

FIG. 4A and FIG. 4B are schematic diagrams illustrating a beam spot distance between a front surface reflection light and a back surface reflection light on a laser irradiation device according to a modified example of the first embodiment.

FIG. 5A and FIG. 5B are schematic diagrams illustrating definition of 1/e² and a full width at half maximum.

FIG. 6 is a schematic diagram illustrating a configuration of a laser irradiation device according to a second embodiment of the present disclosure.

FIG. 7 is a schematic diagram illustrating an interference pattern (horizontal stripes) represented in an interference area of beam spots of a front surface reflection light and a back surface reflection light on an optical detector of the laser irradiation device according to the second embodiment.

FIG. 8 is a schematic diagram illustrating an interference pattern (horizontal stripes) represented in an interference area of beam spots of a front surface reflection light and a back surface reflection light on an optical detector of the laser irradiation device according to a modified example of the second embodiment.

FIG. 9 is a schematic diagram illustrating a configuration of the laser irradiation device according to the modified example of the second embodiment.

### DETAILED DESCRIPTION OF EMBODIMENTS

Hereinafter, embodiments of the present disclosure will be described with reference to the drawings. In the embodiments described hereinafter representing an example of the representative embodiments of the present disclosure, the scope of the present disclosure is not to be understood to be restricted thereby. The description is performed in the following order.

1. Laser Irradiation Device according to First Embodiment

2. Laser Irradiation Device according to Modified Example of First Embodiment

3. Laser Irradiation Device according to Second Embodiment

4. Microparticle Measuring Device

### 1. Laser Irradiation Device according to First Embodiment

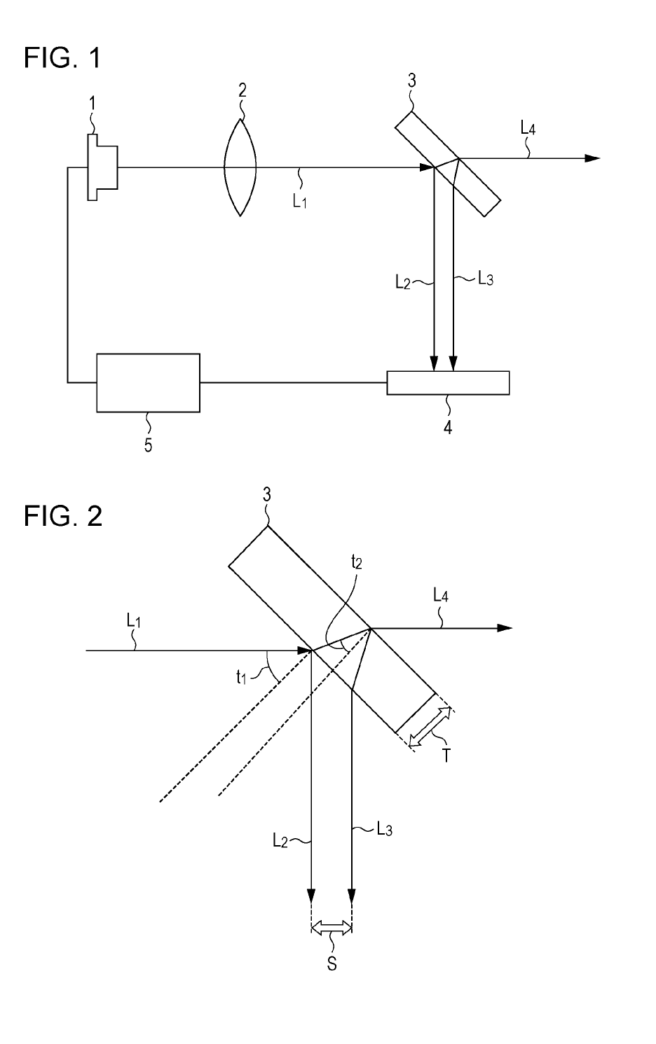

FIG. 1 is a schematic diagram illustrating a configuration of a laser irradiation device according to a first embodiment of the present disclosure.

Output light L₁ output from a light source 1 is formed into parallel light rays by a collimator lens 2, and is input to a flat mirror 3. A part of the output light L₁ input to the flat mirror 3 is reflected, and is guided to an optical detector 4 formed of, for example, a photodiode (see the symbols L₂ and L₃). The remainder of the output light L₁ input to the flat mirror 3 passes through the flat mirror 3, and forms transmission light L₄. A target object as a target of the laser irradiation device is irradiated with the transmission light L₄. For example, when the laser irradiation device is provided in a microparticle measuring device, microparticles flowing in a flow path formed in a flow cell or a microchip are irradiated with the transmission light L₄.

The reflection light reflected by the flat mirror 3 includes front surface reflection light L₂ on the surface of the front side of the flat mirror 3 and back surface reflection light L₃ on the surface of the back side. The front surface reflection light L₂ and the back surface reflection light L₃ are received by the optical detector 4, and signals representing intensity of the light are output to a feedback control circuit 5 by the optical detector 4. The feedback control circuit 5 receives the signal output, and controls the output of the laser light source 1 to be a preset reference value.

Specifically, first, the feedback control circuit 5 compares the signal intensity from the optical detector 4 with the reference value. When the signal intensity from the optical detector 4 is more than the reference value, driving power of the laser light source 1 is decreased to reduce light quantity of the output light L₁. In contrast, when the signal intensity from the optical detector 4 is less than the reference value, the driving power of the laser light source 1 is increased to increase the light quantity of the output light L₁.

By such a control, the feedback control circuit 5 keeps the front surface reflection light L₂ and the back surface reflection light L₃ constant, and stabilizes the intensity of the transmission light L₄ corresponding to the intensity of the front surface reflection light L₂ and the back surface reflection light L₃ to be a constant value.

FIG. 2 is a schematic diagram illustrating a thickness of the flat mirror 3. The thickness of the flat mirror 3 is represented by the symbol T.

The symbol t₁ represents an incident angle of the output light L₁ on the front side surface of the flat mirror 3, and the symbol t₂ represents an incident angle on the back side surface. After the reflection by the flat mirror 3, a distance S occurs between the front surface reflection light L₂ and the back surface reflection light L₃. The distance S is represented by the following formulas.

S=2T·Tan [t2] Cos [t1]

Sin [t1]=n·Sin [t2]

(n represents a refractive index of the flat mirror 3)

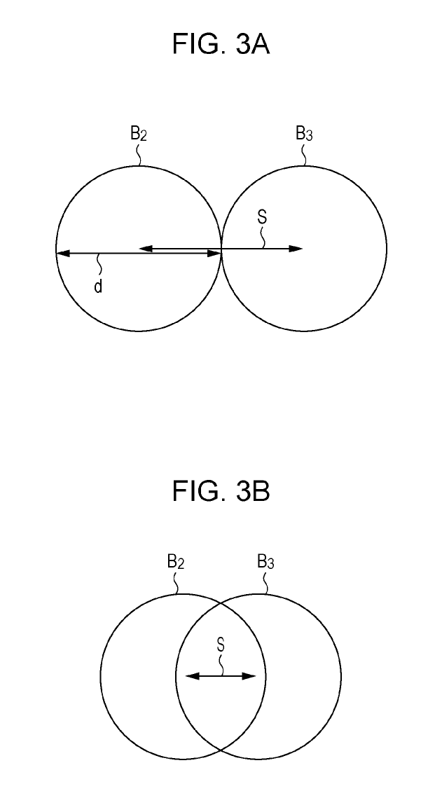

The distance S corresponds to a distance between a beam spot of the front surface reflection light L₂ and a beam spot of the back surface reflection light L₃ on the optical detector 4. In the laser irradiation device according to the embodiment, the thickness T of the flat mirror 3 is set equal to or more than a predetermined value. It will be described with reference to FIG. 3A and FIG. 3B.

FIG. 3A and FIG. 3B are schematic diagrams illustrating a beam spot distance between the front surface reflection light L₂ and the back surface reflection light L₃ on the optical detector 4. FIG. 3A shows that the distance S is set equal to or more than a beam diameter of the output light L₁, and FIG. 3B shows that the distance S is set less than the beam diameter of the output light L₁.

As shown in FIG. 3B, when the distance S is less than the beam diameter (see the symbol d in the figure) of the output light L₁, the beam spot B₂ of the front surface reflection light L₂ and the beam spot B₃ of the back surface reflection light L₃ are overlapped with each other on the optical detector 4, and an interference area occurs. Even when the intensity of the output light L₁ is constant, the interference area becomes a bright pattern or a dark pattern according to slight wavelength change to cause change in the signal intensity of the optical detector 4. Accordingly, it causes the output control of the laser light source 1 by the feedback control circuit 5 to be unstable.

In the laser irradiation device according to the embodiment, the thickness T of the flat mirror 3 is set such that the distance S is equal to or more than the beam diameter d of the output light L₁ to exclude the interference between the beam spot B₂ and the beam spot B₃. Accordingly, even when the light source in which slight wavelength change is inevitable such as when a semiconductor laser is used as the laser light source 1, it is possible to control the output with high precision by the feedback control unit 5, and thus it is possible to obtain the transmission light L₄ with a stable intensity.

As an example of specific numerical values, the incident angle t₁ is 45° and the refractive index n is 1.5, and the distance S is 0.75 T. When the beam diameter d is 4 mm, the thickness T of the flat mirror 3 is preferably equal to or more than 5.3 mm.

To suppress the signal intensity change of the optical detector 4 due to the change in wavelength of the output light L₁, it is preferable that the beam spot B₂ and the beam spot B₃ be not overlapped, but the presence of the overlap may be allowed as long as it is possible to suppress the interference between both. For example, in the case of 20% or less, preferably 10% or less, more preferably 5% or less by the area of the beam spot, there is a case where it is possible to suppress the signal intensity change of the optical detector 4 by the change in wavelength of the output light L₁ in practical use.

### 2. Laser Irradiation Device according to Modified Example of First Embodiment

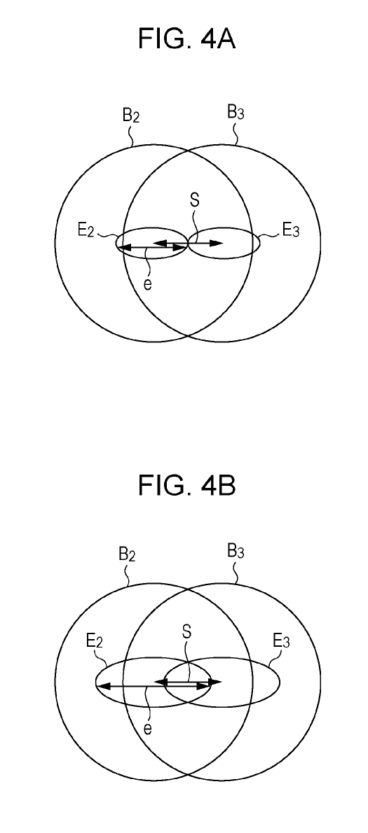

FIG. 4A and FIG. 4B are schematic diagrams illustrating the beam spot distance between the front surface reflection light L₂ and the back surface reflection light L₃ on the optical detector 4 in the laser irradiation device according to a modified example. FIG. 4A shows that the distance S is set to be 1/e² of the output light L₁, and FIG. 4B shows that the distance S is set to be less than 1/e² of the output light L₁ for comparison.

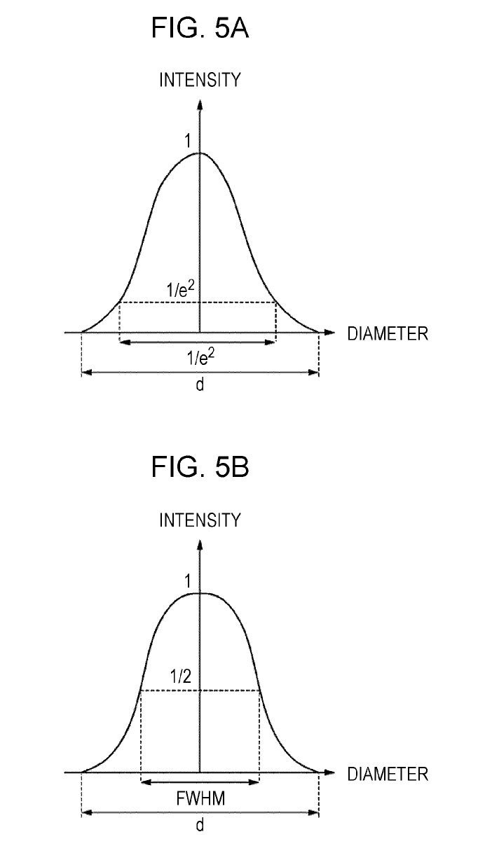

As shown in FIG. 4B, when the distance S is less than 1/e² (see the symbol e) of the output light L₁, the beam spot B₂ of the front surface reflection light L₂ and the beam spot B₃ of the back surface reflection light L₃ are overlapped with each other in the range of 1/e² spots E₂ and E₃. The 1/e² spot is a spot with a size in which the light intensity in the vicinity of a unit area is 1/e² of the maximum value (see FIG. 5A). Since the overlap in this range causes strong interference, a large change is caused in the signal intensity of the optical detector 4 when the wavelength of the output light L₁ is slightly changed, to cause the output control of the laser light source 1 by the feedback control circuit 5 to be unstable.

In the laser irradiation device according to the embodiment, the thickness of the flat mirror 3 is set equal to or more than 1/e² of the output light L₁ to exclude the interference between the beam spot B₁ and the beam spot B₂ in the range of 1/e² spot. Accordingly, even when the light source in which slight wavelength change is inevitable such as when a semiconductor laser is used as the laser light source 1, it is possible to control the output with high precision by the feedback control unit 5, and thus it is possible to obtain the transmission light L₄ with a stable intensity.

To suppress the signal intensity change of the optical detector 4 by the change in wavelength of the output light L₁, it is preferable to suppress the overlap between the beam spot B₂ and the beam spot B₃ as much as possible, and particularly, it is preferable to exclude the overlap in the range of 1/e² with high light intensity. However, the presence of the overlap of the 1/e² spot may be allowed as long as it is possible to suppress the interference between the beam spot B₂ and the beam spot B₃. For example, in the case of 20% or less, preferably 10% or less, more preferably 5% or less by the area of the 1/e² spot, there is a case where it is possible to suppress the signal intensity change of the optical detector 4 by the change in wavelength of the output light L₁ in practical use.

Herein, the modified example in which the distance S is set equal to or more than 1/e² of the output light L₁ and the interference between the beam spot B₁ and the beam spot B₂ is excluded in the range of the 1/e² spot has been described. As another modified example, the thickness of the flat mirror 3 may be set such that the thickness T is equal to or more than a full width at half maximum (FWHM) of the output light L₁. The FWHM spot is a spot with a size in which the light intensity in the vicinity of a unit area is ½ of the maximum value (see FIG. 5B). The overlap in the range of the FWHM spot also causes strong interference. Even in the FWHM spot, the presence of the overlap may be allowed as long as it is possible to suppress the interference between the beam spot B₂ and the beam spot B₃.

### 3. Laser Irradiation Device according to Second Embodiment

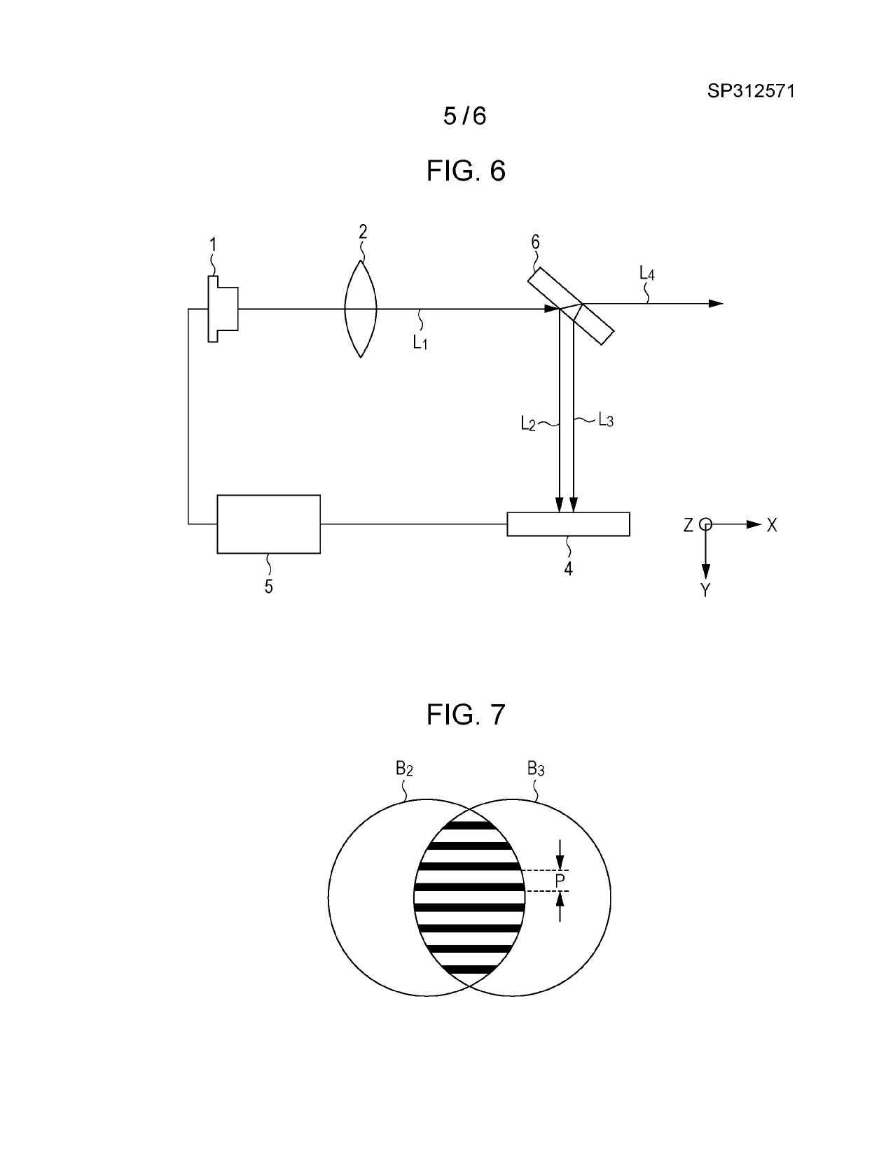

FIG. 6 is a schematic diagram illustrating a configuration of the laser irradiation device according to the second embodiment of the present disclosure.

Output light L₁ output from a light source 1 is formed into parallel light rays by a collimator lens 2, and is input to a wedge-shaped mirror 6. A part of the output light L₁ input to the wedge-shaped mirror 6 is reflected, and is guided to an optical detector 4 formed of, for example, a photodiode (see the symbols L₂ and L₃). The remainder of the output light L₁ input to the wedge-shaped mirror 6 passes through the wedge-shaped mirror 6, and forms transmission light L₄. A target object as a target of the laser irradiation device is irradiated with the transmission light L₄. For example, when the laser irradiation device is provided in a microparticle measuring device, microparticles flowing in a flow path formed in a flow cell or a microchip are irradiated with the transmission light L₄.

The reflection light reflected by the wedge-shaped mirror 6 includes front surface reflection light L₂ on the surface of the front side of the wedge-shaped mirror 6 and back surface reflection light L₃ on the surface of the back side. The front surface reflection light L₂ and the back surface reflection light L₃ are received by the optical detector 4, and signals representing intensity of the light are output to a feedback control circuit 5 by the optical detector 4. The feedback control circuit 5 receives the signal output, and controls the output of the laser light source 1 to be a preset reference value.

Specifically, first, the feedback control circuit 5 compares the signal intensity from the optical detector 4 with the reference value. When the signal intensity from the optical detector 4 is more than the reference value, driving power of the laser light source 1 is decreased to reduce light quantity of the output light L₁. In contrast, when the signal intensity from the optical detector 4 is less than the reference value, the driving power of the laser light source 1 is increased to increase the light quantity of the output light L₁.

By such a control, the feedback control circuit 5 keeps the front surface reflection light L₂ and the back surface reflection light L₃ constant, and stabilizes the intensity of the transmission light L₄ corresponding to the intensity of the front surface reflection light L₂ and the back surface reflection light L₃ to be a constant value.

The laser irradiation device according to the embodiment has a configuration in which the flat mirror 3 of the laser irradiation device according to the first embodiment is replaced by the wedge-shaped mirror 6 in which the front side surface and the back side surface form a predetermined angle. When a traveling direction of the output light L₁ from the light source 1 to the wedge-shaped mirror 6 is an X-axis direction, a traveling direction of the front surface reflection light L₂ and the back surface reflection light L₃ from the wedge-shaped mirror 6 to the optical detector 4 is a Y-axis direction, a direction perpendicular to an XY plane is a Z-axis direction, and the front side surface and the back side surface of the wedge-shaped mirror 6 are inclined in the Z-axis direction.

FIG. 7 is a schematic diagram illustrating an interference pattern represented in the interference area between the beam spots of the front surface reflection light L₂ and the back surface reflection light L₃ on the optical detector 4. By replacing the flat mirror by the wedge-shaped mirror, an interference pattern with a small pitch (a distance between stripes) P appears in an area where the beam spot B₂ of the front surface reflection light L₂ and the beam spot B₃ of the back surface reflection light L₃ are overlapped with each other. When the wavelength of the output light L₁ is changed, the signal intensity of the optical detector 4 is changed by movement of the interference pattern. However, when the pitch P of the interference pattern is sufficiently small, the change of the signal intensity caused by the movement of the interference pattern is small, and the change value reaches a negligible range in practical use. Accordingly, even when the light source in which slight wavelength change is inevitable such as when a semiconductor laser is used as the laser light source 1, it is possible to control the output with high precision by the feedback control unit 5, and thus it is possible to obtain the transmission light L₄ with a stable intensity.

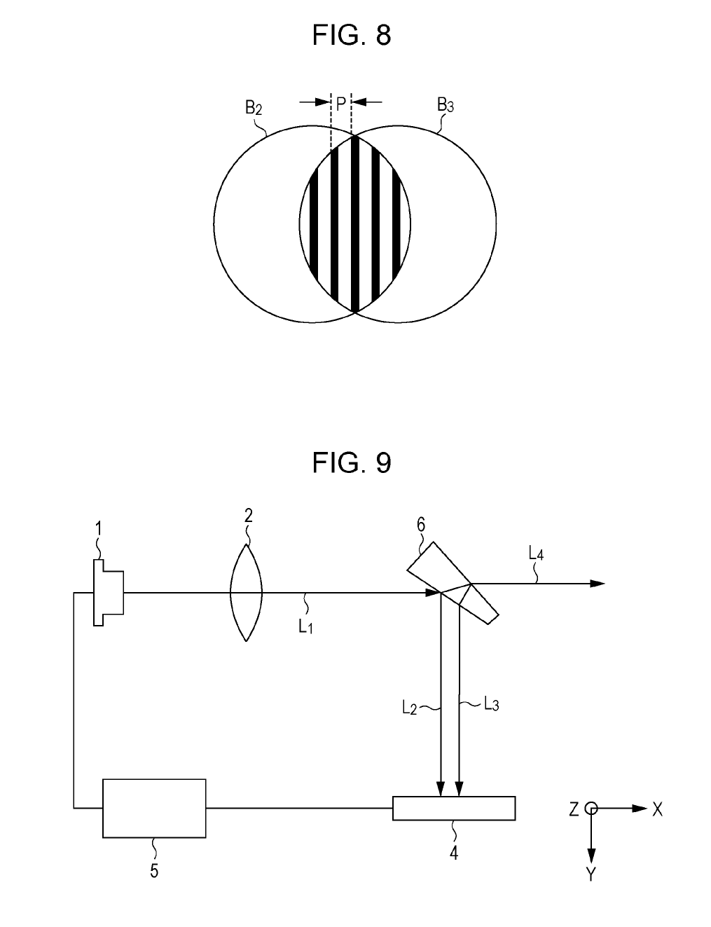

When the wavelength of the output light L₁ is λ and the angle formed by the front side surface and the back side surface of the wedge-shaped mirror 6 is θ, the pitch P of the interference pattern is λ/2θ. As a specific numerical value, when the wavelength λ is 0.488 mm and the angle θ is 0.2°, the pitch P of the interference pattern is 70 μm. The overlap between the beam spot B₂ and the beam spot B₃ is several mm and the pitch P of the interference pattern is 70 μm, the change of the signal intensity of the optical detector 4 caused by the movement of the interference pattern is in a negligible range in practical use. Herein, the interference pattern is the horizontal stripes arranged at predetermined intervals in a direction (horizontal direction) from combining both beam spots in the area where the beam spot B₂ and the beam spot B₃ are overlapped with each other. However, the interference pattern may be vertical stripes arranged at predetermined stripes in a direction (vertical direction) perpendicular to the direction described above (see FIG. 8). When the interference pattern is the vertical stripes, the front side surface and the rear side surface of the wedge-shaped mirror 6 are configured to form a predetermined angle on the XY plane (see FIG. 9). To reduce the change of the signal intensity caused by the movement of the interference pattern, it is preferable that the number of interference patterns represented in the beam spot overlapping area be large. To increase the number of interference patterns, it is more preferable that the interference pattern be the horizontal stripes than the vertical stripes.

In the laser irradiation device according to the embodiment, similarly to the laser irradiation device according to the first embodiment, the thickness of the wedge-shaped mirror 6 may be set such that the distance between the beam spot of the front surface reflection light L₂ and the beam spot of the back surface reflection light L₃ on the optical detector 4 is equal to or more than a predetermined value. Accordingly, it is possible to exclude or suppress the interference between the beam spot B₂ and the beam spot B₃, it is possible to further suppress the change of the signal intensity of the optical detector 4 caused by the movement of the interference pattern, and it is possible to stabilize the intensity control of the transmission light L₄.

### 4. Microparticle Measuring Device

A microparticle measuring device according to the present disclosure is provided with the laser irradiation device described above, and the transmission light L₄ is irradiation light for the microparticles flowing in a flow path formed in a flow cell or a microchip.

The microparticle measuring device includes a flow system that causes flow of microparticles in a flow cell or in a flow path formed on a microchip in a line, an irradiation system that irradiates the microparticles flowing in the flow cell or the like with irradiation light, and a detection system that detects measurement target light such as scattered light or fluorescent light generated from the microparticles irradiated with the irradiation light or substances labeled thereto. The microparticle measuring device may include an analysis system that determines optical characteristics of the microparticles from the intensity of the measurement target light, and a fractionation system that classifies the microparticles according to the optical characteristics on the basis of the determination result.

The microparticle measuring device according to the present disclosure includes the laser irradiation device described above as the irradiation system, and can irradiate the microparticles with the irradiation light with a stable intensity. Accordingly, in the microparticle measuring device, it is possible to measure scattered light intensity or fluorescent light intensity of the microparticles without error, and it is possible to obtain high measurement precision. The flow system, the detection system, the analysis system, and the fractionation system of the microparticle measuring device according to the present disclosure may be configured in the same manner as the related art.

The present disclosure contains subject matter related to that disclosed in Japanese Priority Patent Application JP 2011-062129 filed in the Japan Patent Office on Mar. 22, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A laser irradiation device comprising:
a laser light source;
a mirror that reflects a part of light output from the laser light source and allows the remainder to pass;
an optical detector that detects reflection light reflected by the mirror; and
a feedback control circuit that receives a signal output from the optical detector and controls the output of the laser light source to keep a signal intensity constant,
wherein a thickness of the mirror is set such that a distance between a beam spot of the reflection light reflected by a front surface of the mirror on the detector and a beam spot of reflection light reflected by a back surface of the mirror on the detector is equal to or more than a predetermined value.

2. The laser irradiation device according to claim 1, wherein the predetermined value is any one of a beam diameter 1/e² or a full width at half maximum of the light.

3. The laser irradiation device according to claim 1, wherein the mirror is a wedge-shaped mirror.

4. A microparticle measuring device comprising the laser irradiation device according to claim 1, wherein the light passing through the mirror is irradiation light for microparticles.
